(19) United States
(12) Patent Application Publication
(10) Pub. No.: US 2024/0295865 A1
(43) Pub. Date: Sep. 5, 2024

(54) METHOD FOR MATERIAL-REMOVING MACHINING OF A COMPONENT FOR A TURBOMACHINE

(71) Applicant: MTU Aero Engines AG, München (DE)

(72) Inventors: Maik Zeugner, Lauenau (DE); Martin Broetz, Huenfeld (DE); Christoph Beyer, Langenhagen (DE)

(73) Assignee: MTU Aero Engines AG, München (DE)

(21) Appl. No.: 18/587,483

(22) Filed: Feb. 26, 2024

(30) Foreign Application Priority Data
Mar. 3, 2023 (DE) 10 2023 105 272.1

(51) Int. Cl. G05B 19/401

(52) U.S. Cl. CPC G05B 19/401; G05B 2219/40293; G05B 2219/40548; G05B 2219/49378

(57) ABSTRACT

The present invention is directed to a method for the material-removing machining of a component for a turbomachine that includes the steps of i) recording a distance image by contact-free measurement of at least one surface of the component that is to be machined; ii) comparing the distance image to a computer model of the component and determining the sites of the component that are to be machined based on deviations between the distance image and the computer model; iii) generating a tool path for the sites of the component that are to be machined; and iv) material-removing machining of the component on the basis of the tool path by spark erosion, laser drilling, or conventional drilling.

### BACKGROUND OF THE INVENTION

The present invention relates to a method for material-removing machining of a component of a turbomachine by spark erosion, laser drilling, or conventional drilling.

In spark erosion, the removal of material is based on electrical discharge processes between the tool, that is, the electrode, and the electrically conducting component. To this end, the electrode is brought to the component at a distance of a few micrometers up to tenths of millimeters and, by application of a voltage, an arc flash or flash over (sparking) is brought about. This leads to a local melting or vaporization of the component material and accordingly to the desired removal of material, that is, to spark erosion (also “EDM,” electrical discharge machining). Because the removal of material is localized in the region of the electrode, it is possible to machine individual sites of the component in a targeted manner, for which reason the method is well suited for a utilization in the area of repair, that is, in the rework of used components. Further known are laser drilling and conventional drilling.

### SUMMARY OF THE INVENTION

The present invention is based on the technical problem of specifying an advantageous method for material-removing machining of a component for a turbomachine.

This problem is solved in accordance with the method of the present invention. Here, prior to the actual material-removing machining,
(i) a distance image is initially recorded by contact-free measurement of at least one surface of the component,
(ii) then, for the determination of sites that are to be machined, this distance image is compared to a computer model,
(iii) and, finally, a tool path for the thus determined sites that are to be machined is generated,
(iv) wherein, the machining tool, that is, the electrode in the case of spark erosion, is then moved along this tool path or, alternatively, laser drilling or conventional drilling is used.

Through the detection of the actual state (step i) and the comparison to the target state (step ii), it is possible to generate the tool path in an automated manner (step iii), whereby it is then possible to reduce the machining time, for example, in the case of a larger number of sites that are to be machined or larger deviations from one component to another. This can prove effective, in particular, for components with “different prior histories,” that is, when the actual state from component to component is different on account of the preceding machining and/or utilization. Spark erosion can be used, for example, specifically to expose individual drilled holes of a row/matrix of drilled holes, whereby it is possible using the steps i) and ii) to identify beforehand the drilled holes that are actually to be remachined.

Preferred embodiments are found in the dependent claims and in the entire disclosure, whereby, in the description of features, a distinction is not always made in detail between method and use aspects or device aspects. In any case, the disclosure is to be read in terms of all claim categories. In particular, the description of method steps is always to be read in terms of a device that is equipped with a measuring unit, a machining tool, and/or a computer system and is set up for carrying out the corresponding method.

In general, what is involved in the case of the computer model is typically a CAD (computer-aided design) model of the component. Preferably, the computer model is three-dimensional, with the distance data of the distance images therefore reproducing a three-dimensional trace of the surface of the component. Accordingly, during the comparison, two three-dimensional surfaces are superimposed on one another.

At least the method steps ii) and iii) can take place in a computer-implemented manner; they are preferably executed in the same computer unit. In step ii), for example, it is thereby possible for an image-processing algorithm that compares the distance image to the computer model to be used. For example, features that are detected in the distance image (for example, opened drilled holes, see below) and corresponding features of the computer model are fitted to one another that is, superimposed on one another. Preferably, the recording of the distance images and/or the material-removing machining also is carried out in an automated manner; that is, the distance image is recorded in an automated manner by use of a measuring unit in step i) and/or the machining tool in step iv) machines the component in an automated manner. This automation can be carried out, for example, by way of a suitable robot, which, ideally, is equipped with its own optical sensor system. Accordingly, it is possible to realize an automated, high-precision EDM process.

The automation can also go so far that, for example, a control unit of the machining tool receives the tool path from the computer unit involved in the steps ii) and iii) or the latter directly actuates the machining tool. It is equally possible for the computer unit of the steps ii) and iii) to receive the distance image from the measuring unit or itself be a functioning part of the measuring unit, that is, directly actuate and read-out a distance measuring unit, for example. The tool path can exist as a so-called numerical control (NC) and, in step iv), allow a computerized numerical control (CNC) of the machining tool.

The component that is machined in accordance with the method is intended for a turbomachine; in particular, the component can have a surface that faces a gas channel and of which the distance image is preferably recorded. Preferably, it is a component that, for example, is intended for being positioned on or in the hot-gas channel of a turbine module or, in particular, the combustion chamber. Advantageously, the component can involve a liner, in particular a liner of the combustion chamber, referred to as a combustion liner. On the one hand, such components can be furnished with a large number of drilled holes and, on the other hand, they can be subject to special loads, so that the advantages mentioned at the beginning prove particularly effective (automation and compensation of deviations from component to component).

In a preferred embodiment in accordance with the invention, a used component, that is, a component that has already been used beforehand in a turbomachine, in particular, an aircraft engine, is machined. The component can then be uninstalled in the course of a reinspection and imaged and machined in accordance with the steps i) to iv). On account of different conditions during operation, different states of wear can result even for components of identical construction; that is, conversely, the comparison made by imaging of the actual state can prove effective advantageously.

In a preferred embodiment, the component measured in step i) can be a component that was machined beforehand in a soldering process and/or in a welding process. In other words, the component is preferably coated and/or welded prior to the steps i) to iv), in particular by deposition welding. In such a machining, which can find application especially in the area of repair, drilled holes that are present as such can be unintentionally and deliberately closed, this possibly varying from component to component. Accordingly, there does not exist any predefined drilling grid and the present method can advantageously find application.

In general, in a preferred embodiment, what is involved in the case of sites that are to be machined are drilled holes, especially preferably through holes. These can, in general, have any cross-sectional shape and, in particular, they can be circular. The open drilled holes hereby ensue initially from the distance image, with it being possible to draw a conclusion as the close drilled holes by comparison to the computer model. The closed drilled holes and, under circumstances, also only partially (not fully) opened drilled holes are then imaged in the tool path.

Overall, the component can have, for example, at least 100, 200, 400, 600, or 800 drilled holes (possible upper limits can also depend on the component size, with values lying, by way of example, at 10,000, 5,000, or 2,000 drilled holes).

In accordance with a preferred embodiment, an orientation of the drilled hole or drilled holes that is or are opened in step iv) is also determined and incorporated into the tool path. The orientation of the drilled hole can be afforded, for example, as the orientation of the central axis thereof, such as, for instance, the angle and alignment of the central axis relative to a surface normal (on a theoretically closed surface without a drilled hole). This orientation is incorporated from the computer model into the tool path, which thus includes, in addition to the position of the respective machining, also information about the angle of incidence of the electrode.

In a preferred embodiment, when the distance image and the computer model are compared, a number and/or a pattern of the drilled holes are or is taken into account and, in particular, both are taken into account. In general, alternatively or preferably additionally, it is also possible to take into account a diameter of a drilled hole; that is, insofar as the drilled holes have different diameters, the diameters in the distance image and the computer model are compared and the two of them are fitted in such a way so that the diameters match each other. Regardless hereof, it is also possible to incorporate different diameters into the tool path.

Especially in regard to used components, an advantage of the present method can also lie in the fact that, through the comparison of the actual state and the target state, it is possible to take into account any deformations of the component. In other words, the target state and the actual state differ not only in regard to the state of a respective drilled hole (open/closed), but the drilled hole or drilled holes can also lie at another site owing to deformation in comparison to the computer model. By means of the comparison, it is possible in this regard to interpolate; that is, the computer model is initially expanded/compressed during fitting at the open drilled holes, whereby the drilled holes that are to be opened are then localized in the correspondingly adapted (expanded/compressed) computer model. For the adaptation at an actual deformation, combinations are hereby also possible; that is, the computer model can be compressed in one region and expanded in another region.

In accordance with a preferred embodiment, the distance image is incorporated on the basis of time of flight; that is, the distance values ensue from half of the time of flight of a pulse emitted by the measuring unit (time of flight=interval of time between emission and detection, after intervening reflection at the surface). In this (time of flight, TOF) measurement, the distance value then results from half of the time of flight with the pulse velocity that, in the preferred case, corresponds to a laser-based distance measurement of the speed of light c. The laser can be used to scan the surface of the component line by line or in a grid-like manner, for example, and thereby to capture successively a distance image. This is possible to apply to both shining and matt surfaces.

In accordance with a preferred embodiment, the measuring unit with which the distance image is recorded is moved using the same manipulator that later guides the machining tool in step iv). Initially, therefore, the measuring unit, in particular the laser distance measuring instrument, is placed on the manipulator and then, after the measurement, it is replaced by the machining tool, in particular the machining electrode. This can reduce, for example, the effort required in numerical conversion.

As mentioned in the beginning, the invention also related to a device for material-removing machining of a component. Said device comprises, first of all, the measuring unit and the machining tool, that is, in particular, a laser measuring instrument and a machining electrode for the spark erosion or else a suitable drilling or laser-boring tool. Furthermore, a computer system is part of the device and is set up for carrying out the method steps ii) and iii). In the computer system, commands are therefore stored and, during execution of the program, cause the computer system to compare the distance image and the computer model and to generate a tool path. In regard to further details, both in terms of the device and the method, explicit reference is made to the above disclosure.

In a preferred embodiment, the computer system is additionally set up to cause the machining tool to remove material, in particular to adjust a corresponding machining gap with respect to the component and/or to adjust a corresponding electrical voltage. Furthermore, the computer system is set up to move the machining tool along the tool path by use of a drive or a manipulator.

In a preferred embodiment, the device comprises a portal manipulator, on which the machining tool can be mounted or is mounted. The just mentioned drive can comprise, in general, a plurality of drive units—in the case of the portal manipulator, preferably at least two drive units for movement in a plane. Preferably, in addition, an angle of incidence, that is, an angle of advance of the electrode or its direction of advance relative to the plane can be adjusted. As viewed in a fixed coordinate system, the plane can preferably be aligned vertically; that is, it is possible to realize, along with the movement in a plane, a displacement in height or a lateral displacement.

In a preferred embodiment, the device comprises a rotary or swivel table for clamping of the component for the measurement and/or machining, preferably both. The axis of rotation lies parallel to the plane of a portal manipulator (see above) and/or vertically to the plane, at least in the non-swiveled state (zero position).

### BRIEF DESCRIPTION OF THE DRAWING FIGURES

The invention will be explained in detail below on the basis an exemplary embodiment, whereby the individual features in the scope of the secondary [independent] claims can also be essential to the invention in other combination and, moreover, no distinction is made in detail between the different claim categories.

Shown in detail are:

FIG. 1 a turbomachine, namely, an aircraft engine in a schematic axial section;

FIG. 2a a distance image of a component in schematic illustration;

FIG. 2b a computer model of the component in schematic illustration;

FIG. 2c a comparison between the distance image and the computer model in schematic illustration;

FIG. 3 some method steps in a flowchart;

FIG. 4 a device for material-removing machining of a component by spark erosion and for carrying out the steps in accordance with FIG. 3 in schematic illustration.

### DESCRIPTION OF THE INVENTION

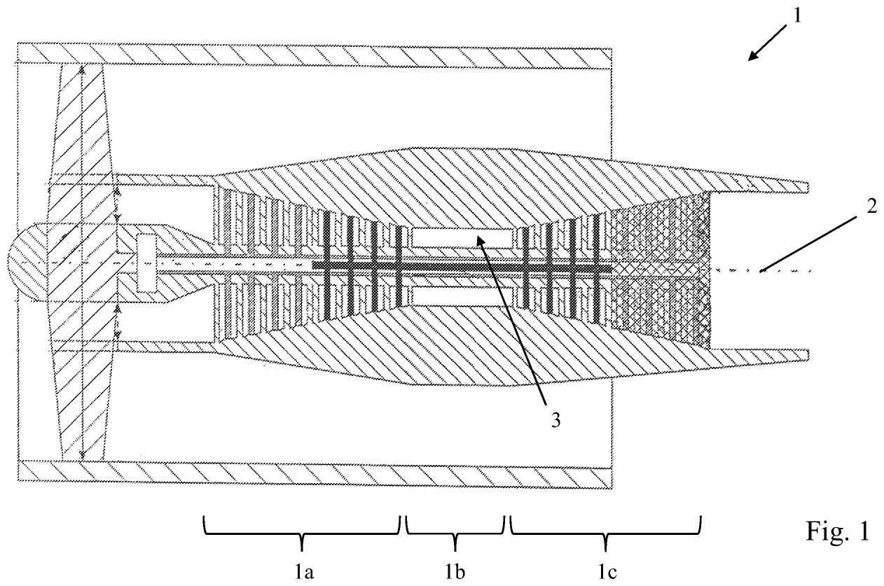

FIG. 1 shows a turbomachine 1, specifically a turbofan engine, in an axial section. The sectional plane thus includes a longitudinal axis 2, around which the rotors rotate during operation. The turbomachine s is divided functionally into a compressor 1a, a combustion chamber 1b, and a turbine 1c. During operation, air intake is compressed in the compressor 1a and then undergoes combustion with admixed fuel, in particular kerosine, in the downstream combustion chamber 1b. The combustion gas or hot gas that is formed undergoes expansion in the turbine 1c and thereby drives the rotors thereof, with proportional conversion into a rotation of the compressor 1a and a rotation of the fan.

The present subject is aimed, in particular, at the reinspection of such an engine, that is, an inspection after a certain period of operation. Especially the components that face the hot gas can hereby be of interest, in particular a combustion chamber liner 3, which is shown here only schematically and is also referred to as a combustion liner. Such a component can have a plurality of drilled holes and, in the course of the rework, in particular during welding repairs, some of them can be closed unintentionally. In the case of a liner having around 1,200 drilled holes, typically 100 to 400 drilled holes can become closed unintentionally, whereby different drilled holes are affected from component to component.

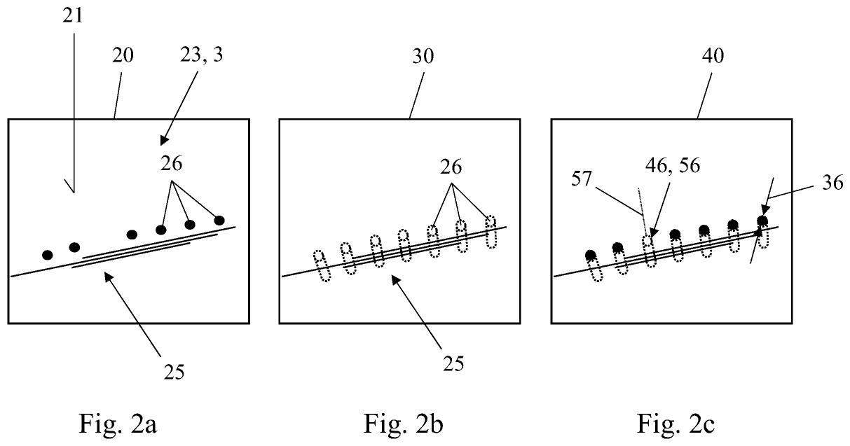

In accordance with the present invention, the closed drilled holes are opened by spark erosion or laser drilling or conventional drilling, whereby, for generation of a tool path, initially a distance image 20 is recorded (compare FIG. 2a for illustration). By use of a laser measuring instrument, a surface 21 of the component 23, that is, in the present case, the combustion liner 3, is measured. In the resulting distance image 20, which, for reasons of clarity, is shown only in a cutout in FIG. 2a, an edge 25 and a plurality of drilled holes 26 can be seen by way of example.

FIG. 2b shows a computer model 30 of the corresponding cutout, in which likewise the edge 25 and, in particular, the drilled holes 26 can be seen. Insofar as only the respective outlet opening that opens in the surface 21 can be seen in the distance image 20, the computer model 30 includes additionally information on the extension of the drilled holes 26 in the component, that is, information on the orientation thereof.

FIG. 2c illustrates a comparison 40 between the distance image 20 and the computer model 30. In this step, the computer model 30 is adapted to the distance image 20, whereby the number and the pattern of the drilled holes evident in the distance image 20, that is, the opened drilled holes 26, and, furthermore, also a diameter of a drilled hole 36 are taken into account. Evident from the comparison 40 is a site 46 that is to be machined, with not only the position, but also an orientation 57 being taken into account. A drilled hole is supposed to be there, but, according to the distance image 20, it has been closed (during the preceding rework). The absent drilled hole 56 is then subsequently introduced by spark erosion (see below).

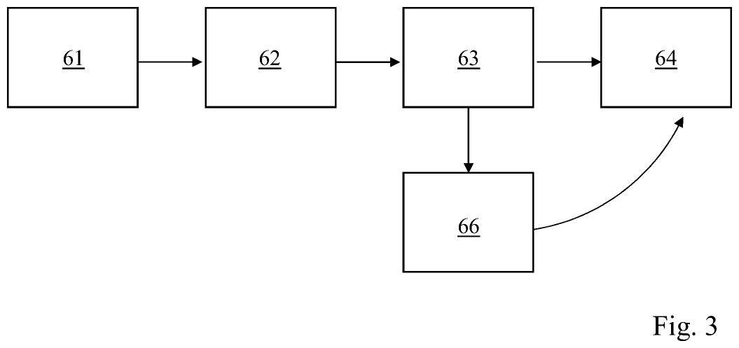

FIG. 3 summarizes some method steps in a flowchart. After the recording 61 of the distance image, it is compared to the computer model 62. On the basis of this comparison, a tool path 66 is generated 63, along which subsequently the machining tool is moved during material-removing machining 64.

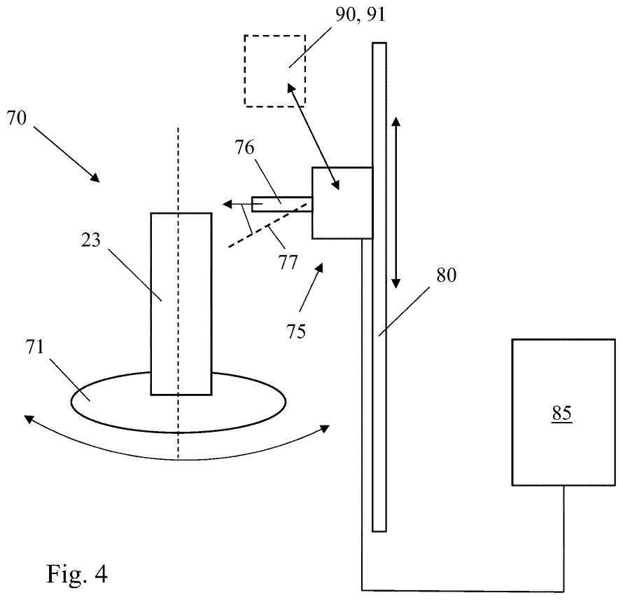

FIG. 4 shows in schematic illustration a device 70 for material-removing machining of the component 23. It is clamped on a rotary or swivel table 71 and the machining tool 75 with the machining electrode 76 is movably mounted relative to it on a portal manipulator 80. An angle of incidence 77 is hereby adjustable. The subject of the device 70 is, furthermore, a computer system 85, in which, on the one hand, the method steps explained on the basis of FIGS. 2a-c, run. On the other hand, the computer system 85 then also actuates the machining tool 75 and the movement thereof by means of the portal manipulator 80. Illustrated cross-hatched is a measuring unit 90, which, in the present case, is a laser distance measuring instrument 91, which, prior to the material-removing machining, is mounted on the portal manipulator 80 in place of the machining tool 75 (that is, in FIG. 4, it has already been exchanged for the machining tool 75).

What is claimed is:

1. A method for material-removing machining of a component for a turbomachine, comprising the steps of:
i) recording of a distance image by contact-free measurement of at least one surface of the component that is to be machined;
ii) comparing the distance image to a computer model of the component and determining the sites of the component that are to be machined based on deviations between the distance image and the computer model;
iii) generating a tool path for the sites of the component that are to be machined;
iv) material-removing machining of the component on the basis of the tool path by spark erosion, laser drilling, or conventional drilling.

2. The method according to claim 1, wherein the component to be machined is a used component and, in the course of an overhaul, is machined in a material-removing manner.

3. The method according to claim 1, wherein the component to be machined was machined prior to step i) in a soldering and/or welding process, by crack welding and/or deposition welding.

4. The method according to claim 1, wherein, a site to be machined is a drilled hole, the position of which is determined in step ii).

5. The method according to claim 4, wherein, in step ii), additionally an orientation of the drilled hole is determined and is incorporated into the tool path.

6. The method according to claim 1, wherein the component to be machined has a plurality of drilled holes, wherein the distance image and the computer model in step ii) are aligned on the basis of the drilled holes.

7. The method according to claim 6, wherein, in step ii), a number, a diameter, and/or a pattern of the drilled holes is taken into account.

8. The method according to claim 6, wherein, in step ii), the computer model is expanded and/or compressed for adaptation to the distance image, wherein the site to be machined in the expanded and/or compressed distance image is determined.

9. The method according to claim 1, wherein the distance image in step i) is recorded using a time of flight-based distance measurement using a laser distance measurement.

10. The method according to claim 1, wherein a measuring unit, with which the distance image is recorded in step i), and a machining tool, with which the component is machined in a material-removing manner in step iv), are moved using the same manipulator.

11. A device for the material-removing machining of a component for a turbomachine, comprising:
a measuring unit configured and arranged for the recording of a distance image by contact-free measurement of at least one surface of the component to be machined;
a machining tool for the material-removing machining of the component by spark erosion, laser drilling, or conventional drilling; and
a computer system configured and arranged
for comparison of the distance image to a computer model of the component and to determine sites of the component that are to be machined, based on deviations between the distance image and the computer model, and
to generate a tool path for the sites of the component that are to be machined.

12. The device according to claim 11, wherein the computer system is additionally configured and arranged
to cause the machining tool to carry out the material-removing machining, and
to cause a manipulator to move the machining tool along the tool path.

13. The device according to claim 11, further comprising a portal manipulator for guiding the machining tool.

14. The device according to claim 11, further comprising a rotating or swivel table for clamping of the component to be machined for the measurement and/or material-removing machining.
